(19) United States
(12) Patent Application Publication
(10) Pub. No.: US 2024/0157296 A1
(43) Pub. Date: May 16, 2024

(54) SYSTEMS, METHODS, AND COMPUTER-READABLE MEDIA FOR PROVIDING A MAINTENANCE RECOMMENDATION FOR A CATALYST

(71) Applicant: BASF Corporation, Florham Park, NJ (US)

(72) Inventors: Yi Liu, lselin, NJ (US); William Hizny, lselin, NJ (US)

(21) Appl. No.: 18/549,195

(22) PCT Filed: Nov. 30, 2021
(86) PCT No.: PCT/US2021/072626

§ 371 Date: Sep. 6, 2023

Related U.S. Application Data
(60) Provisional application No. 63/158,343, filed on Mar. 8, 2021.

(51) Int. Cl. B01D 53/86; F01N 9/00; F02D 41/24; G06F 18/213

(52) U.S. Cl. CPC B01D 53/8696; B01D 53/864; F01N 9/005; F02D 41/2438; G06F 18/213

(57) ABSTRACT

Methods, systems, and computer readable media are disclosed for providing a maintenance recommendation for a catalyst based on a trained machine learning model. The method includes: extract training data comprising one or more parameters from each catalyst of a plurality of catalysts: classify the training data in accordance with at least one catalyst feature at least one of the contaminations of the catalyst: determine a feature vector from the classified training data based on the one or more parameters extracted from catalyst of the plurality of catalysts, generate a performance baseline curve from the training data in accordance with the destruction removal efficiency (DRE) of a gas; and provide based on the trained machine learning model a maintenance recommendation for the catalyst.

### FIELD OF THE DISCLOSURE

This disclosure relates to systems, methods, and computer-readable media for providing a maintenance recommendation for a catalyst using trained machine learning models.

### BACKGROUND

Much of the electrical power used in homes and businesses throughout the world is produced in power plants that burn a fossil fuel (e.g., coal, oil, natural gas). The resulting hot exhaust (flue gas) turns a gas turbine or boils water to produce steam, which turns a turbine to produce electrical power. The flue gas stream is subsequently emitted into the atmosphere.

Among other gases, the flue gas may contain volatile organic compounds (VOCs) and carbon monoxide (CO). Atmospheric CO and VOCs can cause several health and environmental problems. VOCs are also precursors of ground-level ozone (O₃), which contributes to smog formation. Consequently, federal, state, and local environmental regulations mandate that flue gases be treated to reduce the level of VOCs and carbon monoxide before being emitted into the atmosphere.

Typically, the flue gas laden with VOCs and carbon monoxide is treated in a catalytic oxidizer containing a catalyst that will reduce the level of such pollutants by oxidative conversion of the pollutants into water and carbon dioxide. Such catalysts often include precious metal components such as platinum, palladium, rhodium, iridium, osmium, and ruthenium; metal components such as vanadium, copper, manganese, cerium, and chromium; as well as metal oxide catalysts such as manganese oxide or chromium oxide, and combinations of such metal and/or metal oxide catalysts. The expense of these catalyst materials mandates that the effective life of the catalyst be optimized. Moreover, the replacement of a catalyst is not a simple operation and typically requires that all or a portion of the plant emitting the flue gas be shut down, thus adding the unrealized outputs to the total cost of replacement.

Accordingly, it is necessary for plant operators to predict when a catalyst will reach the end of its effective life, and replace the catalyst based on their prediction. However, the conditions under which a given catalyst is operating—e.g., the fuel quality and duty cycle of a power plant—are constantly changing and it is difficult to apply data gathered from one plant or turbine unit to another. Moreover, the field processes that contribute to the performance and aging of a given catalyst are not completely understood. It is therefore difficult and time consuming to predict the end-of-life for the catalyst in a given industrial or power generation application with any sort of accuracy. This makes it difficult for operators to make a sufficiently accurate recommendation as to whether to retain or replace a given catalyst within the short outage windows allowed for the equipment.

### SUMMARY

This disclosure brings machine learning techniques to bear on the decision as to when to replace a given catalyst by providing methods, systems and computer-readable media for using machine learning techniques to quantitatively define a performance baseline curve of catalyst in a particular reaction, so as to base a catalyst maintenance recommendation on objective criteria. In exemplary processes, the performance and contamination levels of a catalyst used in the field may then be determined and compared to the performance baseline curve. If the performance of the catalyst is above the baseline curve, the catalyst may be maintained in service. If the sample performance is at or below the baseline curve, the catalyst may be replaced.

In particular, this disclosure presents a catalyst performance tool (CPT) that performs methods, comprising: (a) extracting, using a computer system, training data comprising one or more parameters from each catalyst of a plurality of catalysts, wherein each parameter is collected from a respective catalyst of the plurality of catalyst; (b) classifying the training data in accordance with at least one catalyst feature at least one of the contaminations of the catalyst and the aging time of the catalyst; (c) determining a feature vector from the classified training data based on the one or more parameters extracted from catalyst of the plurality of catalysts, wherein the feature vector is indicative of whether the catalyst performs normally or abnormally; (d) generating, using the computer system, a machine learning model, wherein the machine learning model is trained based on the feature vector, to predict the function and performance of a catalyst; (e) generating, using the computer system, a performance baseline curve from the training data in accordance with the destruction removal efficiency (DRE) of a gas; and (f) providing, by the computer system based on the trained machine learning model, a maintenance recommendation for the catalyst. The method of the present disclosure also provides, by the computer system based on the trained machine learning model, a maintenance recommendation for the catalyst comprising providing at least one of: (i) a recommendation to maintain (or not maintain) the catalyst; (ii) a recommendation to replace (or not replace) the catalyst at the present time; and (iii) a recommendation to replace (or not replace) the catalyst at a future time. The present disclosure also presents systems and computer readable media for performing the disclosed methods.

### BRIEF DESCRIPTION OF THE DRAWINGS

FIG. 1 shows an exemplary system 1000 for performing methods consistent with the present disclosure.

FIG. 2 is a flow chart showing a method 2000 for generating a maintenance recommendation for a catalyst.

FIG. 3 is a flow chart showing further details of the method 2000 of FIG. 2.

FIG. 4 shows an exemplary portion of a lake of data collected from a sample of BASF Carnet® metal foil CO oxidation catalyst service cases.

FIG. 5 shows another portion of the lake of data collected from the sampling of BASF Carnet® metal foil CO oxidation catalyst service cases installed in exemplary gas turbine Units A-E shown in FIG. 4.

FIG. 6 is a flow chart showing another method 4000 for generating a maintenance recommendation for a catalyst.

FIG. 7 shows candidate performance distribution functions (PDFs) generated with respect to a first test example of the present disclosure.

FIG. 8 shows a Pareto-Levy Stable distribution PDF generated with respect to the first example.

FIG. 9 shows a CO DRE curve generated with respect to the first example.

FIG. 10 shows levels of contaminants found in the first example.

FIG. 11 shows a CO DRE curve generated with respect to a second test example of the present disclosure.

FIG. 12 shows levels of contaminants found in the second example.

### DETAILED DESCRIPTION

The catalyst performance tool (CPT) of the present disclosure provides tools and methods for data analysis and mining and the development and selection of predictive models. The evaluation of a given catalyst's performance occurs in four main phases: (1) a machine learning model is trained using a lake of data gathered from prior service cases; (2) data is gathered from a new service case for which a catalyst usage recommendation is requested; (3) a catalyst usage recommendation is made using the trained machine learning model; and (4) data from the new service case is added to the data lake.

Broadly, the CPT may generate a maintenance recommendation for the catalyst based on information gathered in the data lake. Among other data points, the data may include the CO DRE at different inlet temperatures. The data may be pre-processed using explorative data analysis techniques, such as principal component analysis, and self-organized mapping. Key input variables may be identified based on correlations between the variables. Various machine learning techniques may then be screened using the preliminary dataset. Based on the results of the screening, a specific machine learning technique may be chosen and refined using the complete dataset. A performance baseline curve may then be generated using the refined machine learning technique.

Data obtained from new service cases may then be compared to the performance baseline curve and differences between the baseline and the new service cases may be identified by connecting observed differences with related input variables. Based on this comparison, a maintenance recommendation may be generated with respect to the new service cases. Data derived from each new service case may be iteratively added to the data lake and used to further refine the performance baseline curve.

The maintenance recommendation may identify whether the catalyst may be functioning as expected for a given plant or application and, if the catalyst is not functioning as expected, the maintenance recommendation may further identify reasons why the catalyst is not functioning as expected.

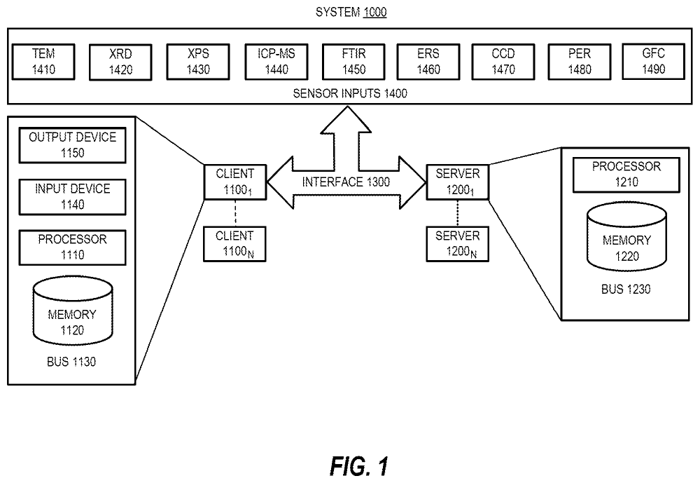

FIG. 1 shows an exemplary system 1000 for performing methods consistent with the present disclosure.

As shown in FIG. 1, system 1000 may be implemented using a client/server architecture, including one or more client-side processing devices 11001-N executing user applications, and one or more server-side processing devices 12001-N executing server applications. The client-side processing device(s) 1100 may communicate with the server-side processing device(s) 1200 via an electronic interface 1300, e.g., a wired and/or wireless communication interfaces, such as a wide-area network (WAN) interface, a local area network (LAN) interface, or the Internet. Alternatively, system 1000 may be implemented as a stand-alone processing device, e.g., processing device 11001.

The client-side processing device(s) 1100 may be implemented as thin clients or thick clients, e.g., using personal computers, server terminals, mobile devices, etc., and may take the form of, e.g., desktop, laptop, or hand-held devices. As shown in FIG. 1, the client-side processing device(s) 1100 may each include one or more processing units 1110 and memories 1120 operatively coupled by a bus 1130.

Processing unit 1110 may include one or more processors (e.g., microprocessors) programmed to perform methods consistent with this disclosure and associated hardware, software, and/or hardwired logic circuitry. The processors may operate singly or in parallel. Memory 1120 may include non-transitory computer-readable media, e.g., both read-only memory (ROM) and random-access memory (RAM). At various times, computer-readable instructions, data structures, program modules, and data necessary for execution of the methods disclosed herein may be stored in ROM and/or RAM portions of memory 1120. In particular, memory 1120 may store an operating system, one or more client-side application programs (e.g., computer or mobile applications programs) and/or program modules, and program data. Bus 1130 may include a memory bus or memory controller, a peripheral bus, and a local bus, each implemented using any of a variety of bus architectures.

The client-side processing device(s) 1100 may each also include one or more user input devices 1140 and output devices 1150. The output devices may include, e.g., a monitor, display, speaker, and/or printer for outputting information to a user. User input devices 1140 may include, e.g., a keyboard, microphone, scanner, and/or a pointing device, such as a mouse or touchscreen, for entering commands or data in cooperation with a graphical user interface displayed on a display or monitor.

The server-side processing device(s) 1200 may be implemented using personal computers, network servers, web servers, file servers, etc. As shown in FIG. 1, the server-side processing device(s) 1200 may each include one or more processing units 1210 and memories 1220 operatively coupled by a bus 1230.

Processing unit 1210 may include one or more processors (e.g., microprocessors) programmed to perform methods consistent with this disclosure and associated hardware, software, and/or hardwired logic circuitry. The processors may operate singly or in parallel. Memory 1220 may include non-transitory computer-readable media, e.g., both read-only memory (ROM) and random-access memory (RAM). At various times, computer-readable instructions, data structures, program modules, and data necessary for execution of the methods disclosed herein may be stored in ROM and/or RAM portions of memory 1220. In particular, memory 1220 may store an operating system, one or more server-side application programs and/or program modules, and program data. Bus 1230 may include a memory bus or memory controller, a peripheral bus, and a local bus, each implemented using any of a variety of bus architectures.

In some implementations, system 1000 may further include one or more sensor inputs 1400 for providing data needed to perform methods consistent with this disclosure. The sensor inputs may include laboratory and/or test equipment for gathering such data, such as a high-resolution transmission electron microscope (TEM) 1410, an X-ray diffractometer (XRD) 1420, an X-ray photoelectron spectrometer (XPS) 1430, inductively coupled plasma mass spectrometer (ICP-MS) 1440, a Fourier Transformed Infrared (FTIR) spectrometer 1450, an Energy Dispersive Spectrometer (EDS) 1460, a CCD camera 1470, a Performance Evaluation Reactor (PER) system 1480, and/or a Gas Filter Correlation CO Analyzer (GFC) 1490.

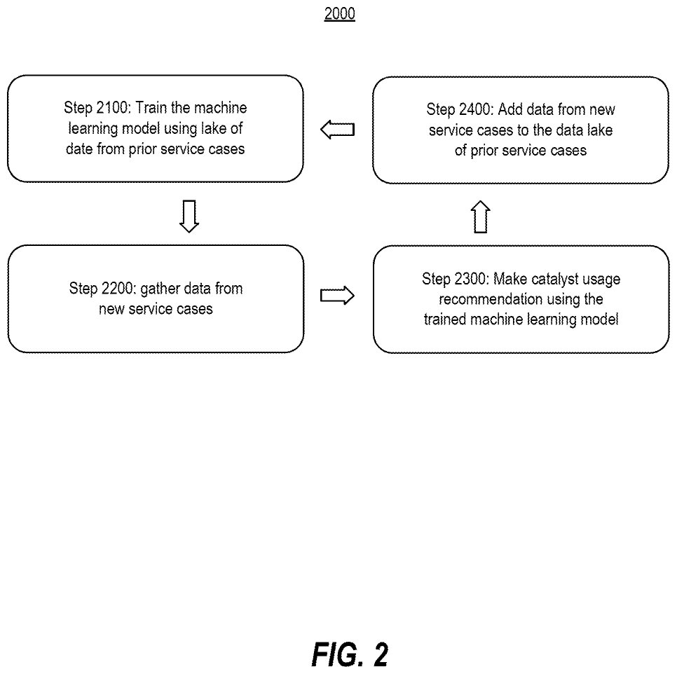

FIG. 2 is a flow chart broadly showing a method 2000 for generating a maintenance recommendation for a catalyst. Method 2000 may be implemented by executing computer-readable instructions, data structures, and/or program modules stored in memories 1120 and/or 1220.

In Step 2100, a machine learning model may be trained using a lake of data gathered from prior service cases. The data lake may be stored in one or more of memories 1120 and/or 1220 and may further be distributed across multiple such memories. The machine learning module may be trained and executed using one or more of server-side processing devices 1200, by one or more client-side processing devices 1100, or a combination of such devices operating serially and/or in parallel.

In Step 2200, data may be gathered from a new service case for which a catalyst usage recommendation may be requested. For example, the data may be gathered using one or more sensor inputs, such as TEM 1410, XRD 1420, XPS 1430, ICP-MS 1440, FTIR 1450, EDS 1460, CCD camera 1470, PER 1480, and/or a GFC 1490.

In Step 2300, a catalyst usage recommendation may be made using the trained machine learning model and the data gathered from the new serviced case. For example, the catalyst usage recommendation may be determined by the trained machine learning model operating on one or more of server-side processing devices 1200, on one or more client-side processing devices 1100, or a combination of such devices operating serially and/or in parallel and output to the user using an output device 1150, such as a display or printer.

In Step 2400, data from the new service case may be added to the lake of available data, from which it may be used to further train and refine the machine learning model. For example, the data from the new service case may be added to the data lake stored in one or more of memories 1120 and/or 1220.

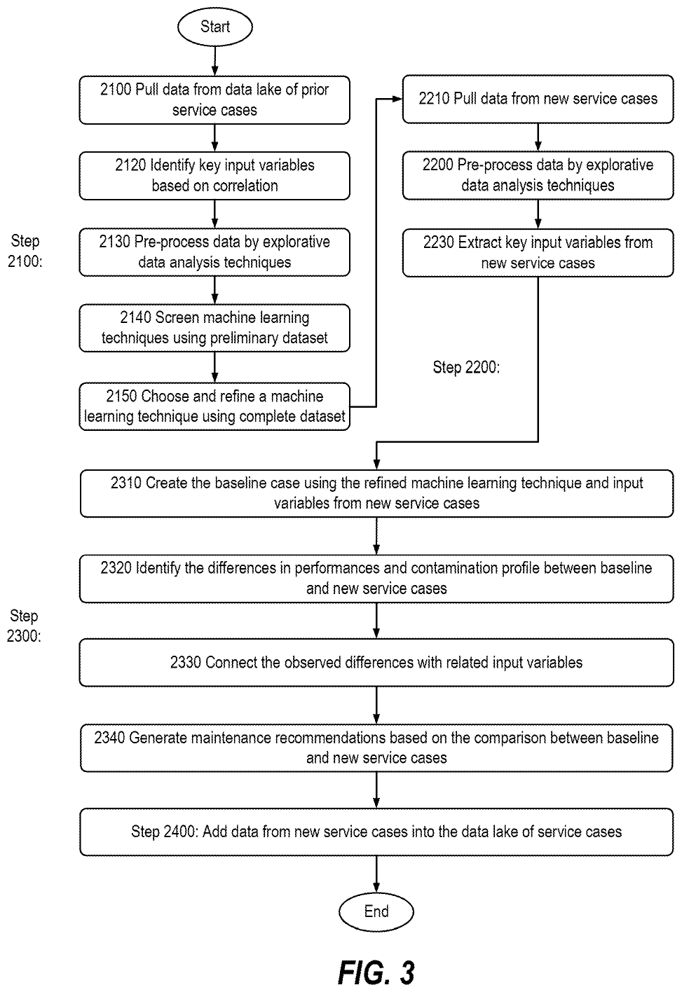

FIG. 3 is a flow chart showing the method 2000 of FIG. 2 in more detail. In particular, FIG. 3 shows certain sub-steps that may be performed within Steps 2100 to 2300.

As shown in FIG. 3, in training a machine learning model using a lake of data gathered from prior service cases (Step 2100), the data may be pulled from the data lake of prior service cases (Sub-Step 2110). Key input variables may be identified based on correlations between the pre-processed data (Sub-Step 2120). The data may then be pre-processed by explorative data analysis techniques (Sub-Step 2130).

Various machine learning techniques may then be screened using a preliminary dataset comprising a sub-set of the complete dataset (Sub-Step 2140). The best-fit machine learning technique may then be chosen and refined using the complete dataset (Sub-Step 2150).

In gathering data from a new service case for which a catalyst usage recommendation may be requested (Step 2200), the available data may be pulled from the new service case (Sub-Step 2210). The data from the new service case may then be pre-processed by explorative data analysis techniques (Sub-Step 2220), and the key input variables may then be extracted from the new service case (Sub-Step 2230).

In making a catalyst usage recommendation using the trained machine learning model (Step 2300), the baseline case may be created using the previously-refined machine learning technique and the key input variables for the machine learning technique may be identified using the new service case (Sub-Step 2310). Any differences in performance and contamination profile between the baseline and the new service case may then be identified (Sub-Step 2320). The observed differences between the baseline and the new service case may then be correlated with the related key input variables (Sub-Step 2330). The maintenance recommendations may then be based on the comparison between the baseline and the new service case (Sub-Step 2340).

As before, the data gathered from the new service case may then be added to the lake of data from prior service cases (Step 2400).

The systems and methods described herein may be implemented with respect to a wide range of catalysts. In some implementations, for example, the catalyst may be a heterogenous catalyst. The catalyst may also be a solid-supported catalyst. The catalyst may include one or more platinum group metals, such as ruthenium, rhodium, palladium, osmium, iridium, and platinum.

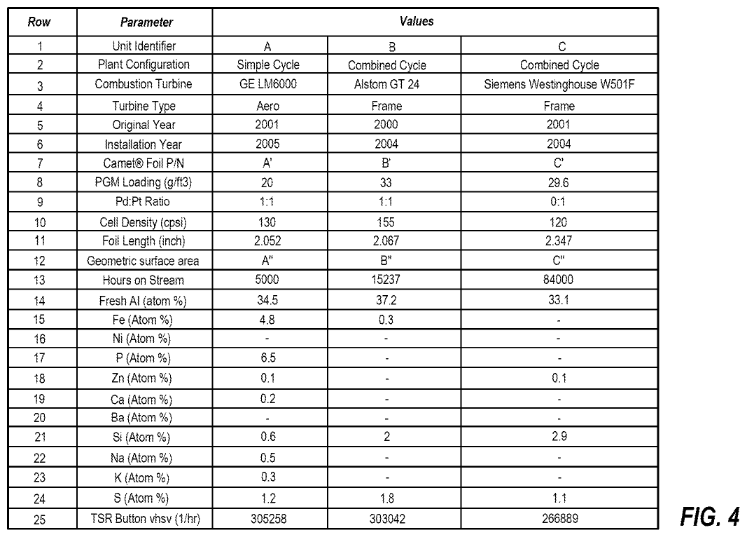

FIG. 4 shows an exemplary portion of a lake of data collected from a sampling of BASF Carnet® metal foil CO oxidation catalyst service cases installed in exemplary gas turbine Units A-C. Although this data is representative, it is in no way limiting, and the data lake described herein may be extracted from other types of catalysts and may include all, some, or none of the parameters shown in FIG. 4.

In FIG. 4, the Unit Identifier (Row 1) may be an alphanumeric text string that uniquely identifies a particular turbine unit. The Unit Identifier may be cross-referenced to identify the location in which the unit may be installed, e.g., by plant name, unit number, and/or geographic coordinates.

Plant configuration (Row 2) indicates the type of plant configuration, such as simple cycle gas turbine for peak-load power supply and combined cycle gas turbine for based-load power generation. The Turbine Model (Row 3) may be a model number or other identifier indicating the commercial model of the subject turbine, e.g., a General Electric LM6000 turboshaft aero-derivative gas turbine engine, Alstom GT 24 gas turbine, or other turbine model.

The Turbine Type (Row 4) indicates the type of turbine, e.g., aero-derivative or heavy frame type.

The Origin Year (Row 5) identifies the year of the design or manufacture of the turbine unit.

The Installation Date (Row 6) identifies the date that the turbine unit was installed.

The Carnet® Foil p (Row 7) identifies the customized design of Carnet® foil.

The PGM Loading (Row 8) indicates the loading of platinum group metals, e.g., in grams per cubic foot.

The Pt and Pd Ratio #(Rows 9) indicate the platinum and palladium ratio numbers of the catalyst.

The Cell Density (Row 10) indicates the density of catalyst cells, e.g., in cells per square inch.

The Foil Length (Row 11) indicates the catalyst foil length, e.g., in inches.

The Geometric Surface Area (Row 12) indicates the surface to volume ratio of the catalyst, e.g., in square feet to cubic feet.

The Hours on Stream (Row 13) indicates the number of hours that the catalyst has been in the active exhaust stream of the turbine.

Fresh Al (Row 14) indicates the atom percent of aluminum on a fresh catalyst, as determined by analysis of XPS spectra.

The data in Rows 15-24 denotes the atom percentages of iron (Fe), nickel (Ni), phosphorus (P), zinc (Zn), calcium (Ca), barium (Ba), silicon (Si), sodium (Na), potassium (K), sulfur (S), respectively, in the aged catalyst as determined by analysis of XPS spectra. This listing of elements is not exhaustive and, in some embodiments, the XPS spectra ay quantify additional elements, such as aluminum (Al), carbon (C), tin (Sn), chromium (Cr), lead (Pb), manganese (Mn), magnesium (Mg), arsenic (Ar), molybdenum (Mo), antimony (Sb), and titanium (Ti). In some implementations, the XPS spectra may be described by quantitative or semi-quantitative surface analysis.

Finally, the TSR Button VHSV (Row 25) is the volumetric hourly space velocity at standard conditions (inverse hour) of the tested catalyst sample at the time of the technical service request.

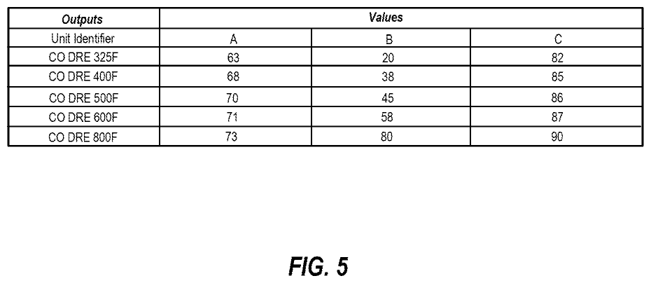

FIG. 5 shows another portion of the lake of data collected from the sampling of BASF Carnet® metal foil CO oxidation catalyst service cases installed in exemplary gas turbine Units A-C shown in FIG. 4. Specifically, FIG. 5 shows the CO DRE measured at the given VHSV at inlet temperatures of 325, 400, 500, 600, and 800° F.

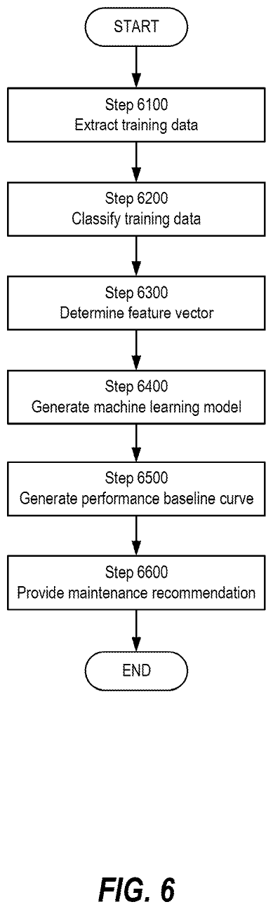

FIG. 6 is a flow chart showing another method 6000 for generating a maintenance recommendation for a catalyst.

In Step 6100, system 1000 may extract training data comprising one or more parameters from each catalyst of a plurality of catalysts, such that each parameter is collected from each respective catalyst in the plurality of catalyst. For example, the system may extract a set of training data as described above in conjunction with FIGS. 4-5.

In Step 6200, the training data may be classified in accordance with at least one catalyst feature described in the training data. For example, the at least one catalyst feature may include the loading of platinum group metals, Platinum to Palladium (Pt:Pd) ratio and cell density. In some implementations, the training data may be classified in accordance with at least one of the contaminations of the catalyst and the aging time of the catalyst. Alternatively, the training data may be classified in accordance with both the contaminations of the catalyst and the aging time of the catalyst. In this regard, the contaminants may include one or more of Fe, Ni, Sn, Cr, Pb, Ti, Mn, Sb, P, Zn, Ca, Mg, Ba, Mo, Si, Na, K, S, and As. The concentrations of the contaminants may be determined by XPS or ICP-MS.

In Step 6300, a feature vector may be determined from the classified training data based on the one or more parameters extracted from each catalyst of the plurality of catalysts. The feature vector may be chosen so as to be indicative of whether the catalyst performs normally or abnormally. In some implementations, the feature vector may indicate a level of conversion of a gas at a given inlet temperature. For example, the feature vector may indicate a level of conversion of CO at an inlet temperature between 325° F. and 800° F. In some implementations, the feature vector may indicate a level of conversion of a gas at a given space velocity. For example, the feature vector may indicate a level of conversion of CO at a space velocity between 100000 h⁻¹ and 500000 h⁻¹.

In some implementations, the determining of the feature vector comprises: detecting, using the computer system, an optimal one of two or more probability density functions (PDFs) of the performance and contamination of the catalyst. In some implementations, dozens of candidate PDFs may be generated and evaluated before an optimal PDF is chosen.

The PDFs may include two or more of the following distributions: Alpha distribution, Anglit distribution, Arcsine distribution, Beta distribution, Beta Prime distribution, Bradford distribution, Burr distribution, Cauchy distribution, Folded Cauchy distribution, Half-Cauchy distribution, Wrapped Cauchy distribution, Chi distribution, Chi-squared distribution, Non-Central Chi-squared distribution, Cosine distribution, Gamma distribution, Double Gamma distribution, Generalized Gamma distribution, Inverted Gamma distribution, Log Gamma distribution, Pearson Type III distribution, Weibull distribution, Weibull Minimum distribution, Weibull Maximum distribution, Double Weibull distribution, Exponentiated Weibull distribution, Inverse Weibull distribution, Erlang distribution, Exponential distribution, Generalized Exponential distribution, Truncated Exponential distribution, Exponentially Modified Normal distribution, Normal distribution, Folded Normal distribution, Generalized Normal distribution, Half-normal distribution, Log-Normal distribution, Power Normal distribution, Power Log-Normal distribution, R Normal distribution, Truncated Normal distribution, Half Exponential Power distribution, F distribution, Non-central F distribution, Fatigue-life (Birnbaum-Saunders) distribution, Logistic distribution, Log-logistic distribution, Generalized Logistic distribution, Half-logistic distribution, Generalized Half-logistic distribution, Pareto distribution, Generalized Pareto distribution, Generalized Extreme Value distribution, Gauss Hypergeometric distribution, Inverse Gauss distribution, Reciprocal Inverse Gaussian distribution, Gilbrat distribution, Gompertz distribution, Gumbel distribution, Right-skewed Gumbel distribution, Left-skewed Gumbel distribution, Hyperbolic Secant distribution, Johnson SB distribution, Johnson SU distribution, Yeo Johnson distribution, Kolmogorov-Smirnov One-sided Test distribution, Kolmogorov-Smirnov Two-sided Test distribution, Laplace distribution, Log-Laplace distribution, Levy distribution, Left-skewed Levy distribution, Pareto-Levy Stable distribution, Lomax distribution, Maxwell-Boltzmann distribution, Mielke Beta-Kappa distribution, Nakagami distribution, T distribution, Non-Central T distribution, Power Law distribution, Reciprocal distribution, Rayleigh distribution, Rice distribution, Semicircle distribution, Triangular distribution, Tukey Lambda distribution, Uniform distribution, Generalized T distribution and Wald distribution.

In Step 6400, the system may generate a machine learning model, which may be trained based on the chosen feature vector, to predict the function and performance of a catalyst. The machine learning model may be trained using supervised or unsupervised training techniques.

Supervised learning allows for prediction based on the data model that may be generated from the training set. Suitable supervised learning techniques may include, e.g., Decision Tree, K-Nearest Neighbors, and Gaussian Naïve Bayes techniques. Unsupervised learning methods generate the data model from the training data itself. Suitable supervised learning techniques may include, e.g., Artificial Neural Networks, Support Vector Machine, Linear Discriminant Analysis, and Logistic Regression techniques. Other suitable supervised and unsupervised learning techniques may be used, such as Bayesian Net Genetic Algorithms/Genetic Programming, Simulated Annealing, Tangled Hierarchies of Sets, Recursive Partitioning, Clustering, Hidden Markov Models, Fuzzy Methods, Semantic Networks, Naïve Bayes Similarity Mapping, Support Vector Machines, Self-organizing Maps, and Gaussian Process techniques.

In Step 6500, the system may generate a performance baseline curve from the training data in accordance with the DRE of a gas, e.g., CO gas at an inlet temperature between 325° F. and 800° F. For example, the performance baseline curve may be generated using pattern recognition techniques.

In Step 6600, the system provides a maintenance recommendation for the catalyst, based on the trained machine learning model. The maintenance recommendation for the catalyst may alternatively, or some combination thereof, indicate that: the catalyst should be (or should not be) maintained in service, that the catalyst should be (or should not be) replaced at the present time, or that the catalyst should be (or should not be) replaced at a future date.

### Examples

The following non-limiting Examples illustrate various aspects and features of the disclosed systems and methods and computer readable media.

In a first test example, catalyst activity and performance were measured using a flow-through reactor using a monolithic sample under the space velocity of 500,000 h⁻¹. The starting concentration of CO and H2O were approximately 100 ppm and 1.5%, respectively. The gaseous reactants (either from a gas tank mixed with nitrogen gas (N₂) or by bubbling N₂ through an organic liquid) were mixed with air prior to entering the reactor. Typical oxygen gas (O₂) concentration in the reactor was about 10%. The reaction products were identified and quantified by a Teledyne Model T300 Gas Filter Correlation CO analyzer.

Precious metal morphology and crystallite size was characterized by high-resolution TEM and XRD. Precious metal oxidation state and speciation was determined by XPS.

TEM data was collected on a JEOL JEM2011 200 KeV LaB6 source microscope with a Bruker Ge EDS system using Spirit software. Digital images were captured with a bottom mount Gatan 2K CCD camera and Digital Micrograph collection software. All powder samples were prepared and analyzed as dry dispersions on 200 mesh lacey carbon-coated Cu grids.

XRD data was collected using a PANalytical MPD X'Pert Pro diffraction system with Cu K-α radiation generator settings of 45 kV and 40 mA. The optical path consisted of a ¼° divergence slit, 0.04 radian soller slits, 15 mm mask, ½° anti-scatter slits, the sample, 0.04 radian soller slits, Ni filter, and a PIXCEL position-sensitive detector. The samples were first prepared by grinding in a mortar and pestle and then backpacking the sample (about 2 grams) into a round mount. The data collection from the round mount covered a range from 10° to 90° 2θ using a step scan with a step size of 0.026° 2θ and a count time of 600 s per step. A careful peak fitting of the XRD powder patterns was conducted using Jade Plus 9 analytical XRD software. The phases present in each sample were identified by search/match of the PDF-4/Full File database from the International Center for Diffraction Data (TODD). Crystallite size of PdO was estimated through whole pattern fitting (WPF) of the observed data and Rietveld refinement of crystal structures.

XPS-spectra were taken on a Thermo-Fisher K-Alpha XPS system which has an aluminum K Alpha monochromatic source using 40 eV pass energy (high resolution). Samples were mounted on double sided tape under a vacuum of less than 5×10−8 torr. Scofield sensitivity factors and Avantage software were used for quantification.

With reference to the method 2000 of FIG. 2, the system 1000 began by extracting CO DRE and contamination data from previous catalyst cases stored in a data lake (Step 2100).

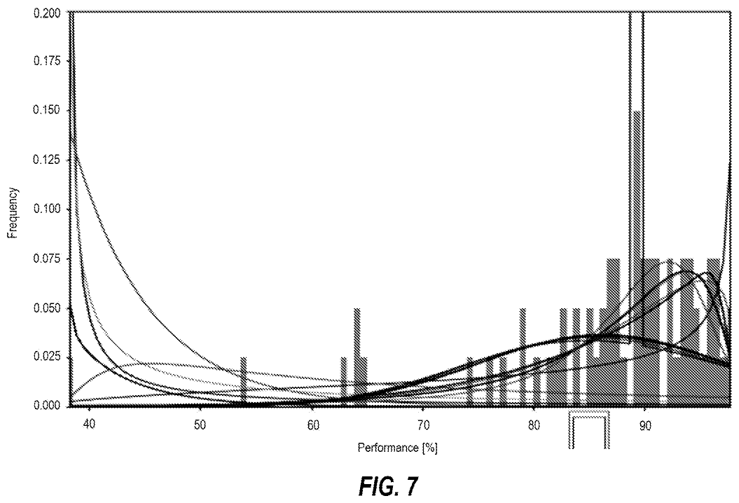

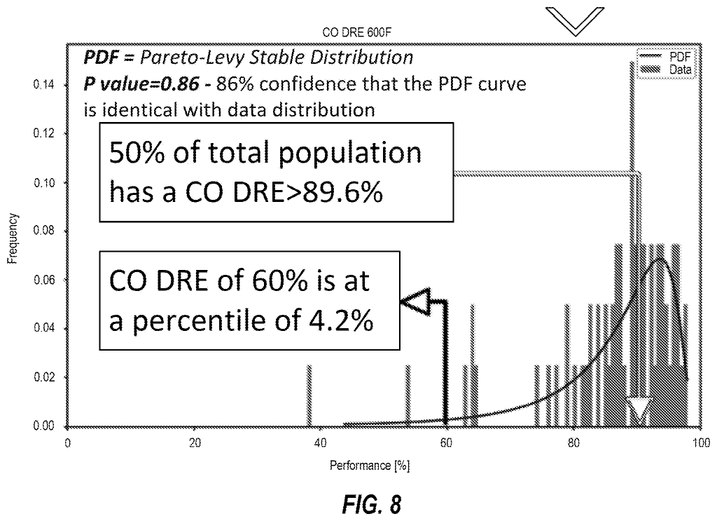

Next (Step 2200), the pattern recognition algorithm was used to create PDFs of performance and contamination. As shown in FIG. 7, 90 different types of candidate PDFs were screened for CO DRE at 600° F. As shown in FIG. 8, the Pareto-Levy Stable distribution was identified as the best one based on the probability value (p-Value), which indicated 86% confidence that the data would fit the Pareto-Levy Stable curve. The CO DRE distribution at 600° F. quantitatively predicted: (1) that 50% of total population has a CO DRE >89.6%; and (2) a 60% CO DRE of 4.2%. The baseline CO DRE curve was then generated by determining the CO DRE of 50% of the total population at different inlet temperatures, specifically, at 325, 400, 500, 600, and 800° F. The baseline contamination profile was obtained in a similar fashion.

In Step 2300, a new catalyst case was tested under the same conditions as the other catalyst cases represented in the data lake. The results were fed into the anomaly detector based on neutral network algorithm to classify the new case as “normal” or “abnormal” by comparing performance and contamination profile of a new case with the Pareto-Levy Stable baseline shown in FIG. 8.

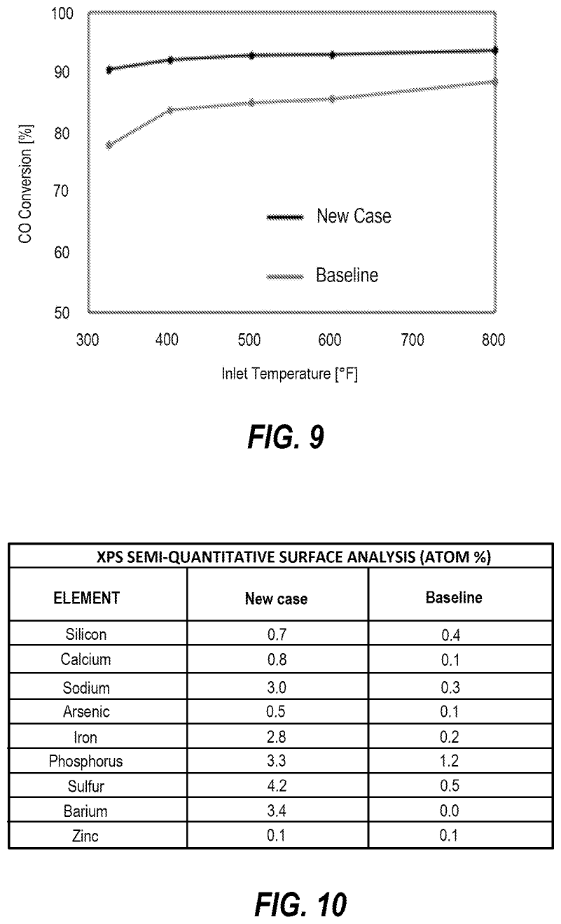

As shown in FIG. 9, the new catalyst case had a CO DRE curve above the baseline CO DRE curve. This case was therefore classified as “normal” from the performance perspective. As shown in FIG. 10, however, the new case also had higher levels of surface contaminants, including Si, Ca, Na, As, Fe, P, S, and Ba than the baseline contamination profile, as determined by semi-quantitative XPS surface analysis. This case was therefore classified as “abnormal” from the contaminant perspective.

Accordingly, the catalyst usage recommendation was to maintain current operation and identify the contamination sources to maximize catalyst useful life.

As a final step (Step 2400), the data from this new case was added to the data lake and used to further train and refine the machine learning model.

In a second test example, Steps 2100 and 2200 of the method of FIG. 2 were conducted as explained above in relation to the first example.

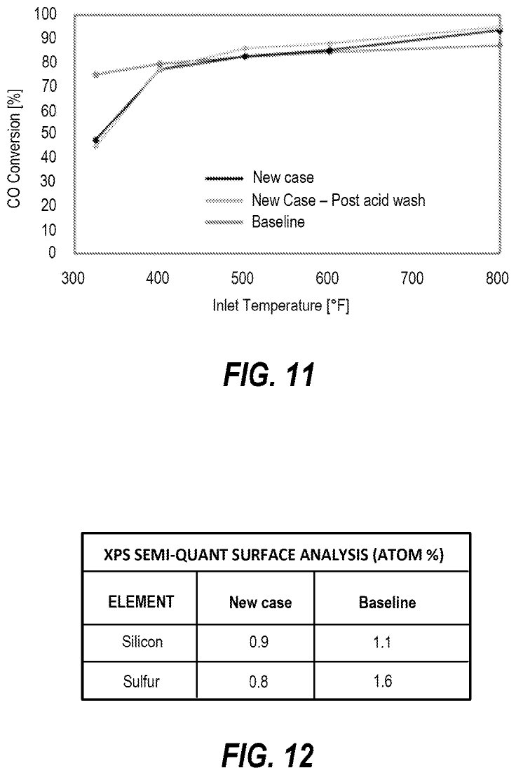

In Step 2300, a second new catalyst was tested under the same conditions as the other catalyst cases in Step 2100. As shown in FIG. 11, this second case was found to have a CO DRE curve partially below the baseline. This case was therefore classified as “abnormal” from the performance perspective.

As shown in FIG. 12, a comparison of the contamination profile of the second example with the baseline contamination profile suggested that there was no excessive surface accumulation of contaminants. This case was “normal” from a contaminant perspective. An acid wash was performed to validate this contamination assessment. The acid wash did not improve the CO DRE performance. Accordingly, the catalyst usage recommendation was to replace the catalyst, as the system emission was approaching the compliance limit.

As a final step (Step 2400), the data from this new case was added to the data lake and used to further train and refine the machine learning model.

The foregoing description has been presented for purposes of illustration. It is not exhaustive and is not limited to precise forms or embodiments disclosed. Modifications and adaptations of the embodiments will be apparent from consideration of the specification and practice of the disclosed implementations. For example, while certain components of system 1000 have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various implementations), adaptations or alterations based on the present disclosure. The elements of the claims are to be interpreted broadly based on the language employed in the claims and not limited to examples described in the present Specification or during the prosecution of the Application, which examples are to be construed as nonexclusive. Further, the steps of the disclosed methods can be modified in any manner, including reordering steps or inserting or deleting steps. In particular, non-dependent steps may be performed in any order, or in parallel.

Other embodiments will be apparent from consideration of the specification and practice of the embodiments disclosed herein. It is intended that the specification and examples be considered as example only, with a true scope and spirit of the disclosed embodiments being indicated by the following claims.

1. A method comprising:
extracting, using a computer system, training data comprising one or more parameters from each catalyst of a plurality of catalysts, wherein each parameter is collected from a respective catalyst of the plurality of catalyst;
classifying the training data in accordance with at least one catalyst feature at least one of the contaminations of the catalyst and the aging time of the catalyst;
determining a feature vector from the classified training data based on the one or more parameters extracted from catalyst of the plurality of catalysts, wherein the feature vector is indicative of whether the catalyst performs normally or abnormally;
generating, using the computer system, a machine learning model, wherein the machine learning model is trained based on the feature vector, to predict the function and performance of a catalyst;
generating, using the computer system, a performance baseline curve from the training data in accordance with the destruction removal efficiency (DRE) of a gas; and providing, by the computer system based on the trained machine learning model, a maintenance recommendation for the catalyst.

2. The method of claim 1, wherein providing, by the computer system based on the trained machine learning model, a maintenance recommendation for the catalyst comprises providing at least one of:
a recommendation to maintain for not maintain) the catalyst;
a recommendation to replace or not replace) the catalyst at the present time; and
a recommendation to replace or not replace) the catalyst at a future date.

3. The method of claim 1, wherein the at least one catalyst feature comprises the loading of platinum group metals, ratio among platinum group metals and cell density.

4. The method of claim 1, wherein the DRE comprises a percentage of conversion of a gas at a given temperature of the inlet.

5. The method of claim 4, wherein the feature vector indicates a level of conversion of a gas at a temperature chosen between 325° F. and 800° F.

6. The method of claim 4, wherein the feature vector indicates a level of conversion of a gas at a space velocity between 100000 h−1 and 500000 h−1.

7. The method of claim 1, wherein the determining of the feature vector comprises:
detecting, using the computer system, two or more probability distribution functions of the performance and contamination of the catalyst;
determining an optimal one of the two or more probability distribution functions of the performance and contamination of the catalyst.

8. The method of claim 7, wherein probability distribution function is chosen from a Normal distribution, Weibull distribution, Johnson SU distribution, Cauchy distribution, Logistic distribution, Log Logistic distribution, Log Gamma distribution, Levy distribution, Maxwell-Boltzmann distribution, Gumbel distribution, Generalized Pareto distribution, Noncentral T distribution, Pareto-Levy Stable distribution, and Gamma distribution.

9. The method of claim 7, wherein probability distribution function is chosen from Normal, Logistic, Weibull, Johnson SU and Pareto-Levy Stable distribution.

10. The method of claim 1, wherein the gas is chosen from carbon monoxide (CO), a volatile organic chemical (VOC), and ozone (03).

11. The method of claim 1, wherein the contaminants are chosen from Fe, Ni, Sn, Cr, Pb, Ti, Mn, Sb, P, Zn, Ca, Mg, Ba, Mo, Si, Na, K, S, and As.

12. The method of claim 11, wherein the contaminants are determined by X-ray Photoelectron Spectroscopy or inductively coupled plasma mass spectrometry.

13. The method of claim 1, wherein the catalyst is a heterogenous catalyst or a solid supported catalyst.

14. (canceled)

15. The method of claim 1, wherein the catalyst comprises a platinum group metal chosen from ruthenium, rhodium, palladium, osmium, iridium, and platinum.

16. (canceled)

17. The method of claim 1, wherein classifying the performance baseline curve from the training data in accordance with at least one of the contamination of the catalyst and the aging time of the catalyst comprises classifying the performance baseline curve from the training data in accordance with at least one catalyst feature, the contamination of the catalyst and the aging time of the catalyst.

18. The method of claim 17, wherein the at least one catalyst feature comprises the loading of platinum group metals, ratio among platinum group metals and cell density.

19. The method of claim 1, wherein generating, using the computer system, the performance baseline curve from the training data in accordance with the DRE of a gas comprises generating the performance baseline curve using pattern recognition techniques.

20. A system comprising:
at least one system configured to:
extract training data comprising one or more parameters from each catalyst of a plurality of catalysts, wherein each parameter is collected from a respective catalyst of the plurality of catalyst;
classify the training data in accordance with at least one catalyst feature at least one of the contaminations of the catalyst and the aging time of the catalyst;
determine a feature vector from the classified training data based on the one or more parameters extracted from catalyst of the plurality of catalysts, wherein the feature vector is indicative of whether the catalyst performs normally or abnormally;
generate a machine learning model, wherein the machine learning model is trained based on the feature vector, to predict the function and performance of a catalyst;
generate a performance baseline curve from the training data in accordance with the destruction or removal efficiency (DRE) of a gas; and
provide based on the trained machine learning model a maintenance recommendation for the catalyst.

21.-38. (canceled)

39. A non-transitory computer readable medium comprising:
a computer program code segment used to extract training data comprising one or more parameters from each catalyst of a plurality of catalysts, wherein each parameter is collected from a respective catalyst of the plurality of catalyst;
a computer program code segment used to classify the training data in accordance with at least one catalyst feature at least one of the contaminations of the catalyst and the aging time of the catalyst;
determine a feature vector from the classified training data based on the one or more parameters extracted from catalyst of the plurality of catalysts, wherein the feature vector is indicative of whether the catalyst performs normally or abnormally;
a computer program code segment used to generate a machine learning model, wherein the machine learning model is trained based on the feature vector, to predict the function and performance of a catalyst;
a computer program code segment used to generate a performance baseline curve from the training data in accordance with the destruction or removal efficiency (DRE) of a gas; and
a computer program code segment used to provide based on the trained machine learning model a maintenance recommendation for the catalyst.

40.-57. (canceled)
